(19) United States
(12) Patent Application Publication
(10) Pub. No.: US 2018/0176845 A1
(43) Pub. Date: Jun. 21, 2018

(54) OPTIMIZED OFFLOADING OF WIRELESS DEVICES TO ALTERNATIVE WIRELESS NETWORKS

(71) Applicant: BandwidthX Inc., Carlsbad, CA (US)

(72) Inventors: Pertti VISURI, Fallbrook, CA (US); Marcel MAHDAVI, Seattle, WA (US); Sven SEUKEN, Zurich (CH); Jay DILLS, San Diego, CA (US); Carlos RIVERA, Ramona, CA (US); Dan ZAGURSKY, San Diego, CA (US)

(21) Appl. No.: 15/845,410

(22) Filed: Dec. 18, 2017

Related U.S. Application Data
(60) Provisional application No. 62/436,165, filed on Dec. 19, 2016.

(51) Int. Cl. H04W 36/22; H04W 36/00

(52) U.S. Cl. CPC H04W 36/22; H04W 36/0072

(57) ABSTRACT

Optimized offloading of wireless devices to alternative wireless networks. In an embodiment, a sector is determined to be busy based on measurement report(s) associated with the sector, wherein the measurement report(s) indicate at least one performance characteristic of the sector. When the sector is determined to be busy, it is determined whether sector(s) of an alternative network, which overlaps with the sector of the home network, are busy based on at least one performance characteristic of the sector(s) of the alternative network. When the sector of the home network is determined to be busy and the sector(s) of the alternative network are not determined to be busy, transmission of an instruction to offload wireless device(s), connected to the home network within the sector of the home network, to at least one of the sector(s) of the alternative network, is initiated.

### CROSS-REFERENCE TO RELATED APPLICATIONS

This application claims priority to U.S. Provisional Patent App. No. 62/436,165, filed on Dec. 19, 2016, the entirety of which is hereby incorporated herein by reference.

This application is related to U.S. Pat. No. 9,084,179, issued on Jul. 14, 2015, U.S. Pat. No. 9,288,831, issued on Mar. 15, 2016, U.S. Pat. No. 9,345,059, issued on May 17, 2016, U.S. Pat. No. 9,549,082, issued on Jan. 17, 2017, U.S. Pat. No. 9,781,277, issued on Oct. 3, 2017, U.S. Patent Pub. No. 2014/0293829, published on Oct. 2, 2014, U.S. Patent Pub. No. 2015/0189580, published on Jul. 2, 2015, U.S. Patent Pub. No. 2017/0094515, published on Mar. 30, 2017, International Patent Pub. No. WO/2016/109742, published on Jul. 7, 2016, and International Patent Pub. No. WO/2016/109745, published on Jul. 7, 2016, the entireties of all of which are hereby incorporated herein by reference.

### BACKGROUND

### Field of the Invention

The embodiments described herein are generally directed to alternative network access, and, more particularly, to offloading wireless devices to an alternative network.

### Description of the Related Art

Today, mobile or other wireless services for wireless devices (e.g., smartphones) are usually provided by utilizing a network that is owned and operated by the same entity that provides the service to the end users' wireless devices. Sometimes, the service provider to the end users has a wholesale agreement with a network owner-operator. Typically, in these cases, each specific wireless device is provisioned to use the network owned by the seller of the wholesale wireless access.

When a wireless device moves outside the coverage area of the primary network (sometimes called the “home network”) and can no longer use it to obtain mobile connectivity or data service, the device may “roam” to another network. Typical roaming agreements mandate that the roaming (target) network must accept the connection and provide the needed data capacity. However, to at least some degree, the amount of network resources provided to the roaming device may be at the discretion of the roaming network and its operator.

Normally, wireless devices are programmed to always look first for the home network signal and, in case a connection can be made, use the home network. This is typically a good strategy for the home network owner, who in most cases is also the service provider, because the cost of roaming is normally significantly higher than the cost of using the home network—especially since the marginal cost of using the service provider's own existing network is typically very low. Roaming costs are normally based on pre-negotiated flat rates for each unit of network capacity (e.g., measured in megabytes (MBs) or megabits per second (Mbps)) used by roaming wireless devices.

Roaming rates and a wireless device's decision to look for a roaming network do not typically take into account the amount of network resources expended by the roaming target network, or the availability, or current state of utilization, of the resources of the roaming target network. However, the amount of network resources, required to provide a given amount of data to a wireless device, can have very high variability.

The biggest factor determining the amount of resources needed is the signal-to-noise ratio (SNR) or signal-to-interference-plus-noise ratio (SINR) of the connection between the network node (e.g., a cell sector radio) and the wireless device. This ratio determines the efficiency of the data encoding that can be used in the communication. Normally, the encoding rate is selected automatically for each connection, and good systems can get relatively close to the theoretical maximum, which is determined by the so-called Shannon Law, a key element of information theory. The encoding rate determines the speed of communication of information over the connection. In today's wireless communications, the practical speeds for connections to wireless devices can vary considerably. A factor of fifty, between a good signal (e.g., in open space close to the cell access point) and a poor, but still useable, signal (e.g., inside a building at the cell edge), is not unusual.

Given that the cost of most mobile or wireless networks are fixed costs to build and operate the network, it makes sense to think of the time of utilization of the network as a basis for measuring the resources used and determining the cost of the network use. Even though several connections are typically served simultaneously and the resource blocks of airtime are allocated automatically among a number of devices, it still comes down to the time a network radio is used to serve a specific device.

From a wireless device's perspective, utility can be measured by the amount of data received or successfully transmitted. Thus, the encoding efficiency directly determines the actual unit cost of providing utility to the device.

In addition to the cost of providing the utility, the connection-encoding rate has a direct impact on the quality of the wireless device's end user's experience, at least in terms of the speed of the connection. Since speed can be improved in a multi-user network by allocating more resources (e.g., network resource blocks) to a particular device, the end user's experience and the cost of the connection are interrelated. However, both the cost and the Quality of Service (QoS) or Quality of Experience (QoE) improve when the signal strength is better and the encoding rate is higher.

Another factor to consider, in the actual cost of expending network resources to serve a particular wireless device, is the opportunity cost of the resources. Most networks have been built to provide a certain amount of total radio access network data capacity from each network node. Depending on the protocol and the network type (e.g., 2G, 3G, 4G/Long-Term Evolution (LTE), 5G, Wi-Fi™, Bluetooth™, mobile satellite service, and/or any other wireless radio access technology) and the number of devices that are utilizing the network node at a given time, there may be under-utilized resources that cannot improve the QoS to the devices served, or the diversion of resources to a new device may have an impact on the QoS of the devices that are already connected to the node.

Conventional mechanisms for making roaming decisions for wireless devices, or charging for the capacity used by roaming devices, do not take into account the current network load or the opportunity cost for the network resources provided.

### SUMMARY

Accordingly, embodiments of an approach are disclosed herein, in which network selection decisions are based on the actual use of resources, qualitative parameters of the current connection compared to the same qualitative parameters of a potential alternative connection, and/or the load and opportunity costs of the available networks.

In an embodiment, a method is disclosed. The method comprises using at least one hardware processor of a remote server to: determine whether a sector of a home network is busy based on one or more measurement reports associated with the sector, wherein the one or more measurement reports indicate at least one performance characteristic of the sector; when the sector of the home network is determined to be busy, determine whether one or more sectors of an alternative network, which overlap with the sector of the home network, are busy based on at least one performance characteristic of the one or more sectors of the alternative network; and, when the sector of the home network is determined to be busy and the one or more sectors of the alternative network are not determined to be busy, initiate transmission of an instruction to offload one or more wireless devices, connected to the home network within the sector of the home network, to at least one of the one or more sectors of the alternative network.

In another embodiment, a system is disclosed. The system comprises: at least one hardware processor; and one or more software modules that, when executed by the at least one hardware processor, determine whether a sector of a home network is busy based on one or more measurement reports associated with the sector, wherein the one or more measurement reports indicate at least one performance characteristic of the sector, when the sector of the home network is determined to be busy, determine whether one or more sectors of an alternative network, which overlap with the sector of the home network, are busy based on at least one performance characteristic of the one or more sectors of the alternative network, and, when the sector of the home network is determined to be busy and the one or more sectors of the alternative network are not determined to be busy, initiate transmission of an instruction to offload one or more wireless devices, connected to the home network within the sector of the home network, to at least one of the one or more sectors of the alternative network.

In another embodiment, a non-transitory computer-readable medium, having instructions stored therein, is disclosed. The instructions, when executed by a processor, cause the processor to: determine whether a sector of a home network is busy based on one or more measurement reports associated with the sector, wherein the one or more measurement reports indicate at least one performance characteristic of the sector; when the sector of the home network is determined to be busy, determine whether one or more sectors of an alternative network, which overlap with the sector of the home network, are busy based on at least one performance characteristic of the one or more sectors of the alternative network; and, when the sector of the home network is determined to be busy and the one or more sectors of the alternative network are not determined to be busy, initiate transmission of an instruction to offload one or more wireless devices, connected to the home network within the sector of the home network, to at least one of the one or more sectors of the alternative network.

### BRIEF DESCRIPTION OF THE DRAWINGS

The details of the present invention, both as to its structure and operation, may be gleaned in part by study of the accompanying drawings, in which like reference numerals refer to like parts, and in which:

FIGS. 1A-1C illustrate example infrastructures, in which one or more of the processes described herein, may be implemented, according to embodiments;

FIG. 2 illustrates overlapping coverage between access points of a home network and alternative network, according to an embodiment;

FIG. 3 illustrates an example processing system, by which one or more of the processed described herein, may be executed, according to an embodiment; and

FIG. 4 illustrates a process for selective offloading of wireless devices from a home network to an alternative network, according to an embodiment.

### DETAILED DESCRIPTION

In an embodiment, systems, methods, and non-transitory computer-readable media are disclosed for a bandwidth exchange (BX). After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Infrastructure

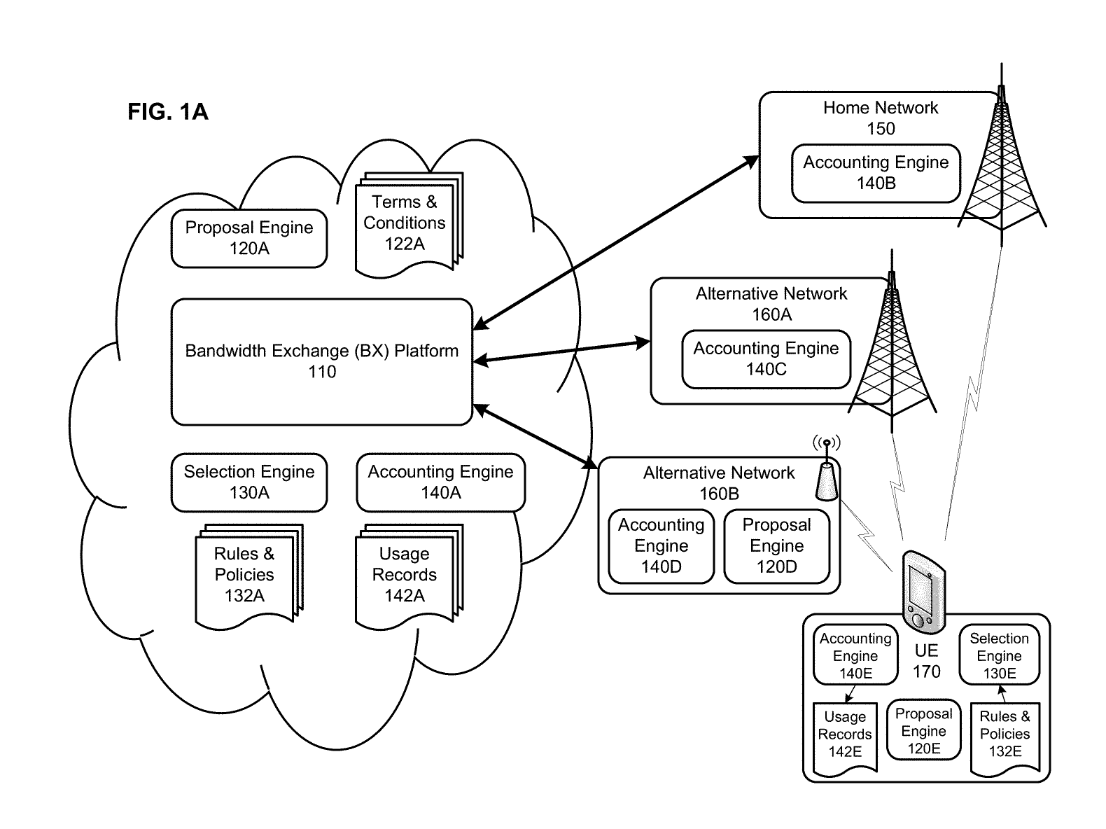

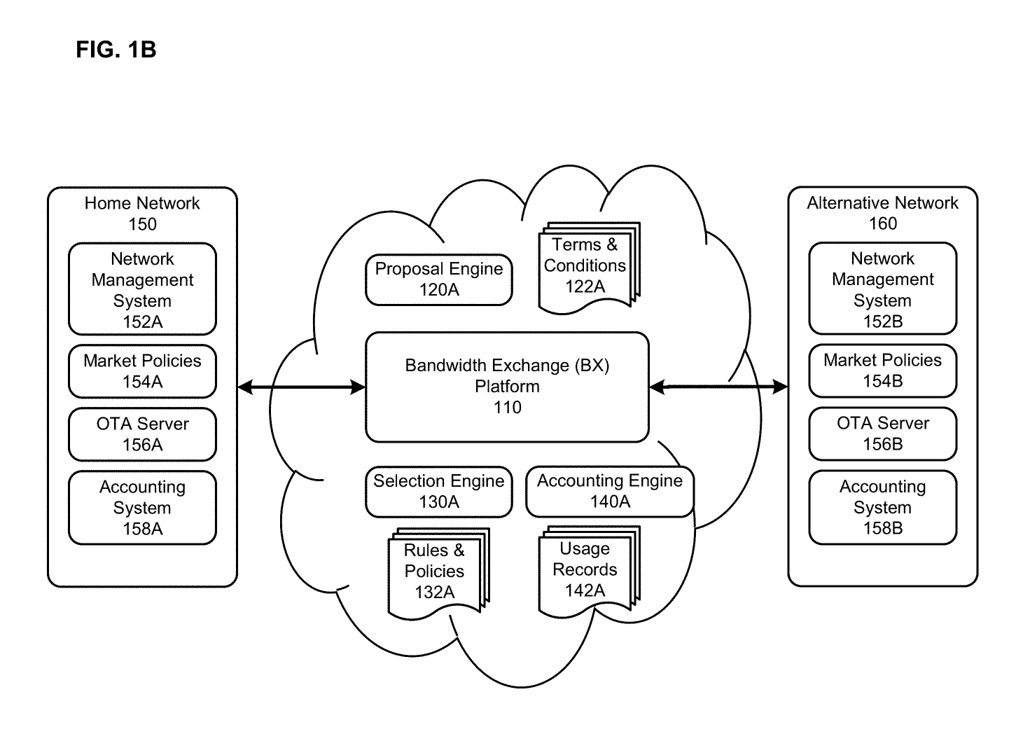

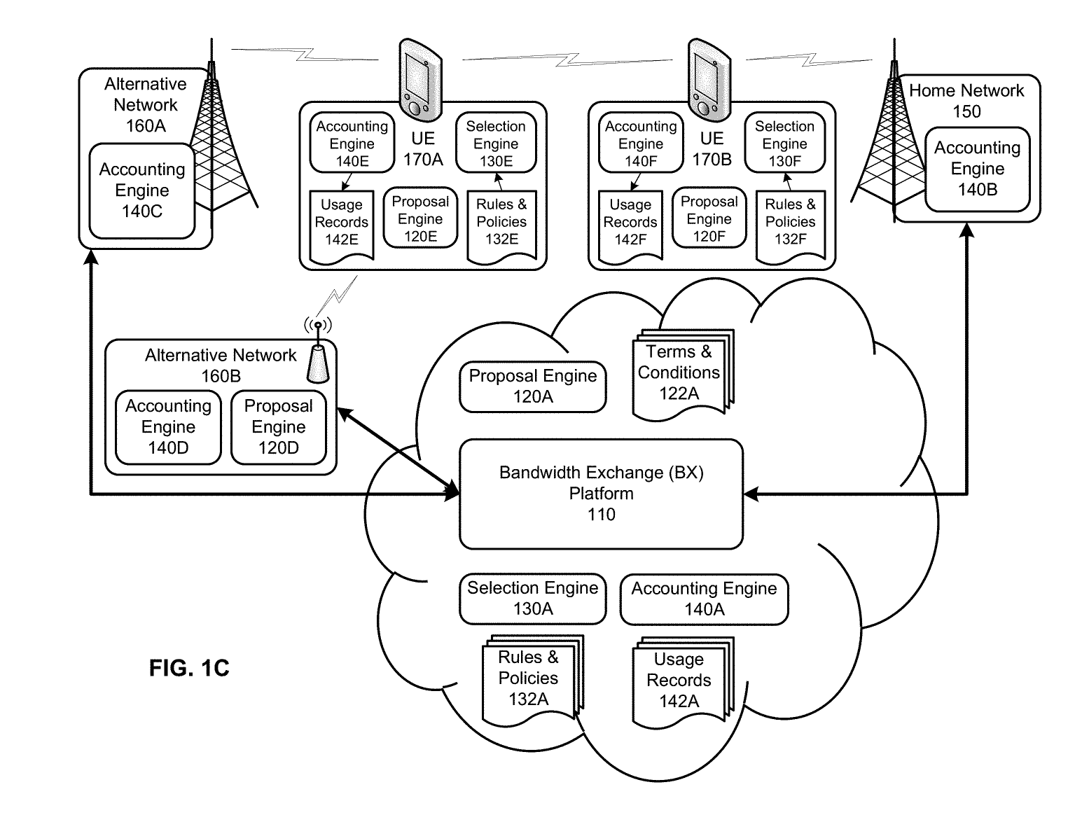

FIG. 1A illustrates an example system for bandwidth exchange (BX), according to an embodiment. Embodiments of the system enable service providers for wireless devices (e.g., mobile devices) and network service providers of home or alternative networks to manage network selection for the devices and conduct micro-commerce on bandwidth or data connectivity, based on one or more parameters pertaining to the characteristics of the available connections to alternative wireless networks and the current situation of the network and device operations.

The bandwidth exchange may be implemented as a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed.

Platform 110 may be communicatively connected via one or more networks (e.g., the Internet) to a home network 150 (e.g., a cellular network) and one or more alternative networks 160 (e.g., a cellular or Wi-Fi™ network)—either of which may provide communication between platform 110 and one or more wireless devices 170 (also referred to herein as “user equipment” (UE)). Home network 150 may comprise a cellular network, and alternative network 160 may comprise a cellular network or a non-cellular network (e.g., a Wi-Fi™ network). A cellular network may utilize 2G (e.g., GSM, GPRS, EDGE, iDEN, TDMA, CDMA), 3G (e.g., CDMA2000, 1×-EVDO, WCDMA, UMTS, HSPA), 4G (e.g., LTE, LTE-A), 5G etc., whereas a non-cellular network may utilize, for example, one or more of the family of 802.11 standards from The Institute of Electrical and Electronic Engineers (IEEE), or other non-cellular network standards. Home network 150 may be operated by a mobile network operator (MNO), a mobile virtual network operator (MVNO), or a wireless service provider. Alternative network 160 may be operated by a MNO, a MVNO, or a wireless service provider, or may be a free Wi-Fi™ service (e.g., a home Wi-Fi™ network, a Wi-Fi™ service provided by a city library, a business, etc.), or a paid Wi-Fi™ service (e.g., offered by an Internet service provider). While only one home network 150, two access points to alternative network 160, and one UE 170 are illustrated, it should be understood that platform 110 may communicate with any number of home networks, alternative networks, access points, and UEs. In addition, UEs 170 may comprise any type or types of computing devices capable of wireless communication, including without limitation, laptop computers, tablet computers, smart phones or other mobile phones, servers, game consoles, televisions, set-top boxes, electronic kiosks, point-of-sale terminals, Automated Teller Machines, and the like.

Each UE 170 may comprise a first radio system, a second radio system, a client application (e.g., a BX application), and a local database. Each UE 170 may be configured to turn on or off one or both of the first and second radio systems independently of each other. The first radio system uses a first wireless communication protocol (e.g., a protocol used for a cellular network) to wirelessly connect to an access point (e.g., a cellular base station providing or otherwise serving one or more sectors of a cellular network), which provides access to home network 150 or alternative network 160A. The second radio system uses a second wireless communication protocol (e.g., Wi-Fi™) to wirelessly connect to an access point (e.g., a Wi-Fi™ access point), which provides access to alternative network 160B. It should be understood that the first wireless communication protocol may be different from the second wireless communication protocol.

Platform 110 may comprise web servers which host one or more websites and/or web services. In embodiments in which a website is provided, the website may comprise one or more user interfaces, including, for example, webpages generated in HyperText Markup Language (HTML) or other language. Platform 110 transmits or serves these user interfaces in response to requests from user systems (e.g., of mobile network operators). In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to platform 110 and the responses from platform 110, including the user interfaces, may both be communicated through one or more networks, which may include the Internet, using standard communication protocols (e.g., Hypertext Transfer Protocol (HTTP), HTTP Secure (HTTPS), etc.). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases that are locally and/or remotely accessible to platform 110.

In embodiments in which a web service is provided, platform 110 may receive requests from one or more external systems, and provide responses in eXtensible Markup Language (XML) and/or any other suitable or desired format. In such embodiments, platform 110 may provide an application programming interface (API) which defines the manner in which the external systems (e.g., an application executed on a UE 170, server, or other device) may interact with the web service. Thus, the external systems, can define their own user interfaces, and rely on the web service to implement or otherwise provide the backend processes, methods, functionality, storage, etc., described herein. For example, in such an embodiment, a client application (e.g., comprising proposal engine 120E, selection engine 130E, and/or accounting engine 140E) executing on one or more UEs 170 may interact with a server application executing on platform 110 to execute one or more or a portion of one or more of the various functions, processes, methods, and/or software modules described herein. The client application may be “thin,” in which case processing is primarily carried out server-side by the server application on platform 110. Alternatively, the client application may be “thick,” in which case processing is primarily carried out client-side by the external system. It should be understood that the client application may perform an amount of processing, relative to the server application on platform 110, at any point along this spectrum between “thin” and “thick,” depending on the design goals of the particular implementation. In any case, the application described herein, which may wholly reside on either platform 110 or UEs 170, or be distributed between platform 110 and UEs 170, can comprise one or more executable software modules that implement one or more of the processes, methods, or functions of the application(s) described herein.

The BX market can be formed by agreements with wireless operators/service providers and/or individual wireless device users, as well as with a number of individuals or companies that own or control alternative radio access resources. The BX market may be implemented by combinations of a proposal engine 120, a selection engine 130, and an accounting engine 140. Proposal engine 120 and accounting engine 140 may reside in (e.g., be executed as software modules by a processor of) platform 110, home network 150, alternative network 160 (e.g., a processor of an access point of alternative network 160B), and/or UE 170. Selection engine 130 may reside on platform 110 and/or UE 170.

FIG. 1B illustrates an example system for providing alternative network access, according to an embodiment. As illustrated, both home network 150 and alternative network 160 may comprise a network management system 152, market policies 154, an over-the-air (OTA) server 156, and/or an accounting system 158. BX platform 110 may communicate with each of these modules of home network 150 and alternative network 160.

In an embodiment, network management system 152 is an overall system that manages its respective network and may comprise several functional categories, including one or more of the following: fault management; configuration management; accounting management; performance management; and security management. Fault management is used to identify, isolate, correct, and log faults that occur in the network. Configuration management is responsible for monitoring system configuration information, tracking changes, and planning for future expansion and scaling. Accounting management is responsible for tracking network utilization information and gathering usage statistics for users. Performance management is used to ensure that network performance remains at acceptable levels. Security management is responsible for controlling access to assets in the network.

In an embodiment, market policies 154 are based on network performance parameters or other indicators and economic factors for offloading, trading, incentivizing, or transferring UEs 170 from home network 150 to alternative network 160. Market policies 154 are used in the initialization and termination of offloads of UEs 170 from home network 150 to alternative network 160. Market policies 154 may include, for example, performance parameters, such as sector PRB usage load, sector busy-hour PRB usage load, sector data rate or throughput per UE (e.g., in Mbps), UE data rate/speed or throughput (e.g., in Mbps), latency or round-trip delay time (e.g., in milliseconds). In addition, market policies 154 may include or incorporate economic factors, associated with these parameters, for determining when to offload or trade UEs 170 from a sector of home network 150 to alternative network 160, to improve the QoS and/or QoE for UEs 170 in the sector. These economic factors may include, for example, a price for offloading a UE 170, reducing sector PRB usage, improving sector average data rate or throughput per UE 170, and/or improving UE data rate/speed or throughput. The price may vary according to the time of day or the day of the week, month, or year, and may change dynamically in response to the demand for services (e.g., within alternative network 160).

In an embodiment, OTA server 156 is a computer server (or cloud instance) that updates and changes data in smart cards (e.g., SIM cards) without having to reissue the smart cards. OTA server 156 provides the ability to introduce new services or to modify the content of smart cards in an efficient and rapid manner. OTA server 156 may have an interface to an operator's back-end system, including business support systems, customer care systems, billing and provisioning systems, etc. In addition, OTA server 156 may have an interface to a short messaging service center (SMSC) for exchanging short messages. OTA server 156 can uniquely identify a SIM card by the Integrated Circuit Card Identifier (ICCID).

In an embodiment, accounting system 158 collects usage data for services used by UEs 170, such that users of UEs 170 can be appropriately billed or charged. The data usage may include, for example, the amount of data transmitted or received (e.g., broken down by time of use). Accounting system 158 may comprise several functions, such as usage measurement, usage aggregation, usage correlation and validation, usage distribution, usage monitoring, usage measurement rules, usage generation, usage reporting, and/or tariff and pricing determination.

FIG. 1C illustrates an example system for providing alternative network access, according to an embodiment in which a UE 170 can connect to another UE 170 in an ad hoc UE-to-UE connection. For example, a UE 170B may be offloaded to alternative network 160 via a direct UE-to-UE or device-to-device (D2D) connection between UE 170B and UE 170A. In this case, UE 170A relays data between UE 170B and a cellular access point (e.g., LTE eNodeB) and/or non-cellular access point (e.g., Wi-Fi™ access point) of alternative network 160.

1.1.1 Proposal Engine

In an embodiment, proposal engine 120 provides access or a reference to the terms and conditions 122 for using a particular connection or connections. In particular, each proposal engine 120 is associated with an alternative network 160 and provides selection engine 130 with information about the connection to the alternative network 160. This information may include the terms and conditions 122, as well as detailed information about the characteristics of the connection to the alternative network 160. For example, the information provided by proposal engine 120, as terms and conditions 122, may include one or more of the following parameters:
(1) Price(s) of using the connection, which may vary according to the time of day or the day of month or year, and which may change dynamically in response to the current demand from other selection engines 130.
(2) Level of security available for using the connection.
(3) Historical data about bandwidth, data rate, throughput, packet loss, stability, jitter, and/or other performance characteristics of the connection. Selection engine 130 may use this data, but may have UE 170 conduct its own tests to determine the bandwidth and/or other performance characteristics of the connection (e.g., jitter, packet delays of retransmissions during the connection, etc.), and makes its own determination about the quality of the connection.
(4) Sponsorship for or promotions related to the connection (e.g., websites or specific promotions available or required through the connection). For example, some connections may be sponsored by advertisers. In the case, the nature of the products being advertised and/or the frequency and obtrusiveness of the advertisements may be communicated by proposal engine 120 to selection engine 130, such that selection engine 130 may consider the connection based on this information. Some end users may be interested in advertisements on certain topics (e.g., topics close to the end users' hearts), but may wish to avoid connections which will require advertisements on other topics or certain undesired topics.
(5) Quality of the connection (e.g., Internet connection provided through the connection); and/or
(6) Special instructions from the operator of home network 150 and/or the end user of UE 170.

The set of parameters used in the selection process will depend on the complexity of the given proposal engine 120 and selection engine 130. For example, a less sophisticated selection engine 130 may only be capable of selecting a connection based on signal strength and price. However, a more sophisticated selection engine 130 may be capable of considering more information and alternatives in the terms and conditions 122, provided by a proposal engine 120, to thereby increase its capabilities.

Other information, pertaining to terms and conditions 122 of using an access point, may be relevant. For example, some access points may belong to a network of hotspots controlled by a wireless operator or wireless Internet Service Provider (ISP) that offers fixed-fee or other special pricing to subscribers of their services. If the end user of UE 170 is a subscriber to such a hotspot network, terms and conditions 122 would normally be stored in selection engine 120E, and the hotspot access point would provide information identifying that it belongs to the hotspot network (for example in its SSID). Alternatively or additionally, proposal engine 120 for the access point may provide the indication that the access point belongs to the hotspot network.

There may be special information transmitted by the UE's home network 150. For example, from the home-network operator's point of view, the desirability to offload a UE 170 to alternative network 160 may depend on the load within the sector (e.g., on the cellular tower) of home network 150 to which UE 170 is connected. To manage the connections in an optimal way, BX platform 110 may instruct selection engine 130 for a UE 170 in a particular sector of home network 150 and/or at a particular time to seek the lowest price alternative even when a connection to home network 150 is available (e.g., if the load on that sector is above a threshold).

Proposal engine 120 may be implemented as a module on an access point of alternative network 160 (e.g., proposal engine 120D), elsewhere within alternative network 160, and/or on BX platform 110. A proposal engine 120, associated with an access point, provides information about that access point (e.g., the availability, connectivity services provided, and/or other information) to UEs 170 (e.g., to selection engine(s) 120 associated with each UE 170). This information may include the terms and conditions, including the price, of using connectivity through the access point, and may include detailed information about the characteristics of the connection to alternative network 160 provided by the access point. Implementations of proposal engine 120 may vary depending on the sophistication and capabilities of the access point, the organization or individual that owns or controls the access point, and/or the technical and business arrangements that provide the connectivity (e.g., Internet connectivity) for the access point.

In some implementations or scenarios, a proposal engine 120, associated with an access point, may reside outside the access point (e.g., on another computing device in alternative network 160 or on BX platform 110). This allows access points that can only broadcast their Service Set Identifiers (SSIDs) and/or unique identifiers (e.g., a Basic SSID (BSSID), Media Access Control (MAC) address, etc.) to be used in the bandwidth exchange market to provide connectivity services to UEs 170.

Selection engines 130 of UEs 170 that can receive the beacons of an access point can obtain the terms and conditions and other information from BX platform 110, using the identifying information (e.g., SSID, a BSSID, MAC address, or other unique identifier) of the access point as a reference. This may be facilitated by including, in the SSID of the access point, an indication or information about its participation in alternative network 160 (e.g., by including a specific character string in the SSID). Thus, selection engine 130 may check for the terms and conditions for a given access point without having to go through lists of participating access points' identifiers. In an embodiment, BX platform 110 may periodically download unique identifiers (e.g., BSSIDs MAC addresses, etc.), SSIDs, locations, associated terms and conditions, and/or any other information about participating access points to alternative network 160 that are located in the vicinity of the current location of UE 170. This expedites access to the relevant terms and conditions, and makes it possible to have this information available at UE 170, even in situations where UE 170 does not have an open data connection to the Internet or BX platform 110 (e.g., UE 170 is not able to see a cellular access point or is a Wi-Fi™ only device). The current location of the UE 170 can be obtained from a GPS system, if available, or by having the access point transmit identifiers of access points in its range (e.g., regardless of whether or not the access points are registered with BX platform 110) and having BX platform 110 correlate these access point identifiers to a database of access point locations. If the location of a UE 170 is constantly changing (e.g., because UE 170 is moving in a vehicle), BX platform 110 can extend the range of access points, to include in the list of access points transmitted to UE 170, in the direction of the UE's movement. The downloads may be scheduled to happen at regular intervals or they may be scheduled to take place every time a UE 170 has network access (possibly establishing a minimum interval between downloads). This enables UEs 170 that only have one radio system (e.g., Wi-Fi™) to utilize the bandwidth exchange.

In an embodiment, a UE 170 may trigger or request information about available access points (e.g., access points not already configured for use by UE 170) from BX platform 110. For example, UE 170 may provide its current location to BX platform 110. In response, BX platform 110 may compile one or more access points (e.g., a list of access points within the vicinity of the UE's current location and/or available for use by UE 170) that have been registered to provide connectivity services in alternative network 160. BX platform 110 may provide this list (e.g., via a download over home network 150 or alternative network 160) to UE 170. The list may include, for each access point, one or more of the following:
(1) Party that is offering the connectivity service.
(2) Offered price that can be used in all circumstances, for at least a minimum time period (e.g., few minutes), until UE 170 can connect to BX platform 110 to get an updated price. This allows UE 170 to connect to alternative network 160, even when UE 170 is a Wi-Fi™ only device or when conditions make it impractical to get a current price over home network 150 (e.g., due to congestion or UE 170 being out of coverage of home network 150). The offered price may be specific to UE 170, a type of UE 170, the end user of UE 170, a class of end users, a time of day, a day of week or month, etc. BX platform 110 can be aware of the attributes of UE 170, and may tailor the offered price in accordance with those attributes.
(3) Sponsor(s). A sponsor is a party that pays for the connectivity services. For example, a cellular or Internet service provider may pay for services made available to its subscribers, a business (e.g., coffee shop, online gaming provider, etc.) may pay for services made available to its patrons, etc.

The list of access points, provided by BX platform 110, may include information for a number of access points within a certain radius (e.g., ten miles) of the current location of UE 170 or a location specified by the end user of UE 170 (e.g., via a user interface). Selection engine 130E of UE 170 may scan for available access points and compare the connectivity options provided by the visible access points based on rules and policies 132. This comparison may include measuring the performance characteristics (e.g., signal strengths, data speed) of one or more visible access points. Selection engine 130E combines the information from BX platform 110 with the measured performance characteristics to make a selection of a connection. For example, rules and policies 132 may provide that: (1) if the performance characteristic (e.g., signal strength) is above a threshold (e.g., set to indicate adequate performance) for two or more visible access points, select the access point offering the lowest price; and (2) if the performance characteristic (e.g., signal strength) is below the threshold for all of the visible access points, select the access point having the highest signal strength. Once a connection has been established, it may be reevaluated, according to rules and policies 132, if the performance characteristic falls below a set threshold or at regular intervals. In the case that intervals are used, the intervals may be static or may depend on the price of the current connection or any other parameter known to UE 170.

When a UE 170 establishes a new connection, one or more communications on the previously existing connection may be transferred to the new connection, prior to termination of the previously existing connection. In other words, UE 170 may associate communication with the access point supporting the new connection and disassociate the communication with the access point supporting the previously existing connection. In addition, UE 170 may send a usage report for the previously existing connection (e.g., once it has been terminated, assuming it is registered with BX platform 110) to BX platform 110 over the new connection. BX platform 110 may store this usage report for billing, payment, analysis, and/or other purposes.

In an embodiment, an access point of alternative network 160 may execute a proposal engine 120D that stores the terms and conditions 122 for using the services provided by the access point, along with other information, and provide these terms and conditions 122 and/or other information directly over the wireless link to a selection engine 130E of each UE 170 that requests to receive them. This can be done using the 802.11u standard, if both devices are capable of using this protocol. A multi-round, two-way negotiation (or an auction) about terms and conditions 122 may be automatically carried out between UE 170 and access point 160B. In this case, access point 160B may offer a price, UE 170 may counter with a lower price, the policies in the access point may enable it to offer another price based on the counter offer, and so on and so forth. In some environments, a subset of access points may have internal proposal engines 120D, while another subset of access points rely on proposal engines within alternative network 160 or on BX platform 110 (i.e., proposal engine 120A).

Terms and conditions 122 may have short periods of validity, and connectivity may be re-negotiated at specific intervals, as situations in terms of need and available capacity will constantly vary. In the event that an access point is managed by proposal engine 120A on BX platform 110, terms and conditions 122 for that access point, including the validity periods for terms and conditions 122, may be automatically downloaded to UEs 170. In the event that the access point is managed by proposal engine 120A and UE 170 is managed by selection engine 130A on BX platform 110, terms and conditions 122, including their validity periods, may be made available to both proposal engine 120A and selection engine 130A. In some implementations, BX platform 110 can instruct a UE 170 to immediately terminate a connection with an access point and/or temporarily or permanently block UE 170 from attempting to connect to that access point.

1.1.2 Selection Engine

A UE 170 that participates in the BX market may have the ability to establish multiple wireless connections and/or change one or more wireless connections. For simplicity a system that utilizes both Wi-Fi™ and cellular wireless connections is described, but different implementations can use any combination of other available wireless technologies. Selection engine 130 (e.g., selection engine 130A and/or selection engine 130E) manages this connectivity for UEs 170 through a network connection between each UE 170 and BX platform 110. Selection engine 130 bases its operation on rules and policies 132 (e.g., rules and policies 132A and/or rules and policies 132E) that have been set by the wireless operator and/or the end-user of UE 170. In some implementations there is a selection engine 130 on both UE 170 and BX platform 110. These two selection engines 130A and 130E operate in tandem using the rules and policies 132A and 132E, respectively. In some cases, rules and policies 132A are controlled by the operator and rules and policies 132E are controlled by the user. There can be a set of default rules and policies 132, so that the user does not need to do anything to begin participating in the BX market.

In an embodiment, selection engine 130E and rules and policies 132E, together with information about access points to alternative network 160 within the sector or other vicinity of UE 170 may be downloaded to UE 170, and subsequently used to make an initial decision of whether or not to establish a connection to alternative network 160, even when no other network connection is available. This initial decision may be based on a set of rules and policies 132E that is simpler and less dynamic, for example, than rules and policies 132A. Once a connection to BX platform 110 and selection engine 130A can be established, selection engine 130A can use rules and policies 132A (e.g., together with additional information, such as price, performance characteristics, etc.) to revisit and possibly revise the initial selection. Rules and policies 132A may be updated more frequently than rules and policies 132E. In the event that the initial selection is revisited and revised to abandon the connection based on rules and policies 132A, there may be a minimum time period that must elapse before the connection is severed, in order to avoid the negative user experience that may result from a momentary connection.

UE 170 may comprise mobile equipment (ME), a user identity module, and a BX application (e.g., a client application executed by a processor of UE 170) stored in the memory of the device (e.g., along with other applications). Each UE 170 that participates in the bandwidth exchange may have the ability to establish multiple wireless connections, for example, via multiple technologies (e.g., 2G, 3G, 4G/LTE, 5G, Bluetooth™, mobile satellite service, and/or any other wireless radio access). Selection engine 130 manages the connectivity available to UE 170.

In an embodiment, selection engine 130 can operate independently of UE 170 on any system (e.g., platform 110) that communicates with a standard authentication server. Alternatively, selection engine 130 may operate as a cooperative combination of functions executed on UE 170, platform 110, and the authentication server. When the selection engine 130 for a given UE 170 is executed on platform 110, the selection engine 130 may manage the UE's connections through a network connection (e.g., formed by home network 150 or alternative network 160). Selection engine 130 may base its management operation on rules and policies 132. Rules and policies 132 may be set by the home network operator, alternative network operator, and/or the end user of UE 170.

In an embodiment, a selection engine 130A is executed by a platform 110 and a selection engine 130E is executed by UE 170. In this case, selection engines 130A and 130E may operate in tandem using both rules and policies 132A, stored on platform 110, and rules and policies 132D, stored on UE 170. Rules and policies 132A may be controlled by the home and/or alternative network providers, whereas rules and policies 132E may be controlled at the discretion of the end user of UE 170. A default set of rules and policies 132E may be provided, so that the user does not need to do anything to activate the system.

Rules and policies 132 control which of the connection(s), available to a UE 170, will be selected at any given time. The level of sophistication and complexity in the selection process of selection engine 130 may vary for different implementations. For example, one or more of the following parameters may be considered during the selection process:
(1) Price and/or other terms and conditions for using the services offered by an access point of alternative network 160 (i.e., the ask price). These may be provided by proposal engine 120. The ask price may be specific to a particular access point or group of access points, and may depend on a number of factors, including the time of day, day of the week or month, dynamic network operating parameters (e.g., load), and/or any other information available to proposal engine 120. The ask price may also depend on the characteristics and parameters associated with UE 170 (e.g., the service provider of home network 150). The ask price may also depend on the buyer of the wireless services (e.g., the end user of UE 170 or service provider of home network 150). For example, if the end user of UE 170 has a subscription with a certain service provider (e.g., cable broadband service provider) and the particular access point of alternative network 160 belongs to a network of the service provider or an affiliate or partner of the service provider (e.g., a provider of hotspots), the ask price for that particular end user may be zero. The ask price for other end users, who do not have such a subscription, may be non-zero.
(2) Price and/or other terms and conditions offered by the buyer for using services of an access point of alternative network 160 (i.e., the bid price). The bid price may depend on a number of factors, including the time of day, day of the week or month, dynamic network operating parameters (e.g., load) of home network 150, information about UE 170, the end user's contract with a service provider of home network 150, the end user's association with other organization(s), and/or any other information available to selection engine 130.
(3) Quality of the signal from the access point providing the connection, based on a measurement of signal strength (e.g., RSSI, SNR, SINR) or any other relevant parameter that may be detected by each radio system of UE 170 for which a connection is available.
(4) Level of security available for using the connection.
(5) Traffic load on the network providing the connection (e.g., physical resource block usage, peak or busy-hour traffic, etc.).
(6) Throughput capacity of the connection.
(7) Reliability (e.g., packet loss) of the connection.
(8) Latency and jitter of the connection.
(9) Bandwidth, or any other specific characteristic of connectivity, needed by each application executing or to be executed on UE 170.
(10) Specific application, executing on UE 170, that is requesting or using the services provided by the access point of alternative network 160.
(11) Specific service (e.g., website being accessed) to which UE 170 (e.g., an application executing on UE 170) is requesting access.
(12) Sponsorship for or promotions related to the connection (e.g., websites or specific promotions available or required through the connection);
(13) Buyer(s) for the service. For a specific service, the service provider of home network 150 may be requesting access to the service, but the buyer may be a sponsor of the service, such as a company that provides access to data services when a specific application is being executed in the foreground or is the main active application on UE 170. The buyer could also be the service provider of home network or the end user of UE 170. Each potential buyer of a particular service may have a different bid price.
(14) Acceptability, to an application or the end user, of a delay (in transmitting data from UE 170 to the network or transmitting data from the network to UE 170. For example, an application provider or end user may specify an acceptable delay for a data transmission in terms of a time that may elapse between the request to transmit the data and the actual transmission of the data. Thus, an end user could specify that a delay of one hour is acceptable for uploading photographs to a website (e.g., social media site). In this case, selection engine 130 may wait up to one hour to see if a free or cheap connection (i.e., zero price or price below a certain threshold) becomes available for the upload. If the one hour elapses without such a connection becoming available, selection engine 130 may then select a connection with a higher cost (i.e., non-zero price or price above the certain threshold). Different acceptable delays may be set for different cost levels or other characteristics of the connection (e.g., terms and conditions other than price).
(15) Estimated drain on battery power in UE 170 resulting from use of the connection.
(16) Speed, reliability, or other performance characteristics of any alternative connection available to UE 170 (e.g., a connection that UE 170 is currently using or has used in the past). For example, if the data transfer speed of a connection, provided to UE 170 by the mobile network operator with whom the end user has an agreement, falls below a set threshold, the selection decision may be affected. As another example, if UE 170 is connected to an access point of alternative network 160, but the data transfer speed, packet loss, or other performance characteristic falls below a set threshold, a prior selection decision could be revisited using this information about the existing connection.
(17) Result of a speed test or other performance test of a connection. UE 170 may conduct a speed test or other performance test of its connection to an access point at any time (e.g., immediately after initially establishing the connection). The performance test may be based on observing the data access speed of another application that is communicating over the connection, or it may comprise a speed test that is specifically initiated by UE 170 to check the quality of a new connection immediately after establishing the connection. If the result of the test indicates that the tested performance characteristic (e.g., speed) is below a set threshold (which may depend on UE 170 and/or applications using the connection), selection engine 130 may reverse the decision to select the particular access point and/or network for the connection and select a new access point and/or network. In an implementation, the performance test utilizes criteria that include the data transmission speed observed immediately before connecting to a new access point. For example, the decision to connect may be reversed if the data transmission speed is not higher than the speed observed before connecting to the new access point.
(18) Geographic location of UE 170.
(19) Radio (e.g., cellular base station) to which UE 170 is connected.
(20) Information about the movement of UE 170, as determined, for example, from motion sensors or accelerometers on UE 170 or from tracking Global Positioning Data (GPS) collected by UE 170.
(21) Special instructions, for example, from the network operator(s), UE 170 end users, and/or access point operator(s).

In some instances, some of the connection alternatives may have lower cost or be free. For example, one or more access points of alternative network 160 may be sponsored by a business that provides free wireless access in exchange for acceptance of commercial messages and advertising. Free access to certain web sites or services may be provided by certain companies (e.g., gaming companies) or by certain applications (e.g., gaming applications). Service providers or vendors may sponsor connectivity that allows the end user to visit the provider's or vendor's website to make purchases. Other access points may offer lower cost or free connectivity, but require the right to collect location-based information of the end user or may require responses from the end user to survey(s). One example of collecting useful location-based information would be to collect the GPS location of UEs 170 at specific intervals (e.g., to measure the speed of traffic flows on roads and freeways). This could be a commitment by the end user of UE 170 that would be valid, even when UE 170 is connected through home network 150, and which could earn privileges to use alternative network 160 as a form of compensation.

Selection engine 160 may select which data connection to use for each of the applications executing on UE 170. In one embodiment, these selections are performed on a real-time, moment-to-moment basis, using the rules and policies 132 and current information about each available connection (e.g., price and/or other parameters listed above). This information may be available directly from the access point, for example, by using the 802.11u communication standard, or it may be obtained from BX platform 110 based on a reference system.

In an embodiment, selection engine 130 uses rules and polices 132, set by the operator of BX platform 110 and/or the end user of UE 170, that authorizes the use of connections based on a combination of two main parameters: The speed or other performance characteristic of the connection that is currently available to UE 170 from home network 150 and the cost of an alternative connection available to UE 170 through alternative network 160. Rules and policies 132 may have thresholds for the performance characteristic and the cost. The thresholds may be tiered. For example, selection engine 130 may offload a UE 170 from home network 150 to alternative network 160 under either of the following tiered conditions: a) offload a UE 170 from home network 150 to alternative network 160 to increase its data speed that is below 5 Mbps for up to fifty cents per time period; b) offload a UE 170 from home network 150 to alternative network 160 to increase its data speed that is below 1 Mbps for a price of up to two dollars per time period; and so on and so forth.

In an embodiment in which selection engine 130 is at least primarily hosted on BX platform 110, UE 170 will send the set of selection parameters to selection engine 130A on BX platform 110, and selection engine 130A will return to UE 170, the identifying information and necessary authentication information for connecting to a connectivity provider that will provide the selected connection.

In an alternative embodiment in which selection engine 130 is at least primarily hosted on UE 170, selection engine 130E on UE 170 will use the available selection parameters (e.g., from proposal engine 120) to make the selection of an access point through which it will establish a connection. UE 170 may then communicate this information to BX platform 110 and responsively receive the authentication information that will enable the connection. The authentication information can be transmitted and/or exchanged using a protocol (e.g., 802.1x, EAP) that is the same or different from the protocol used in communication.

In an embodiment, selection engine 130 compares the ask price and bid price, which may both depend on a number of parameters as described above. If the ask price (e.g., plus a possible commission or other compensation for the operator of BX platform 110) is lower than the bid price, selection engine 130 establishes a clearing price for the connectivity service. This price may be a price per byte transmitted, price per time of connectivity, or any other unit of pricing. The clearing price is then applied by accounting engine 140 to establish the necessary payments and settlements between the buyer and the seller of the connectivity service.

Once a connection is selected, selection engine 130 may provide, to UE 170, any information that is necessary to establish the connection through the selected access point. This information may include authentication and authorization information. The authentication and authorization information may include wireless passphrases or passwords, account identification information and passwords, credentials for an access control gateway, detailed information about how to post a user name and password to captive portal, digital certificates, and/or other access control tokens and parameters. Selection engine 130 controls these authentication and authorization elements, which may be stored in encrypted form in a database of selection engine 130A and/or 130E. If the authentication and authorization elements are stored in selection engine 130E on UE 170, the elements may be downloaded together with other information about the access points in the vicinity of UE 170. These authentication and authorization elements may have expiration times and may be refreshed at regular intervals. The authentication and authorization elements are made available to the UE's connection functions only at the time of connection and are subsequently erased from the UE's memory. The end user will not have any access or visibility to the authentication or authorization information, used by selection engine 130, except in implementations or scenarios in which the end user must manually provide such information to connection functions of UE 170.

In an embodiment, based on the connection selections and measured data traffic through each connection, UE 170 generates a detailed record on the actual use of each connection to alternative network 160, utilizing accounting engine 140. At intervals, accounting engine 140 transmits the usage record to BX platform 110, including identifying information of UE 170 and/or the end user and identifying information of each of the access points that provided each used connection. The usage record may also identify the selected buyer of each connection, include the negotiated price for each connection, indicate the terms and conditions in force at the time the connection was used, and/or include connection parameters. The reporting of connection parameters can be performed in any manner. For example, the reporting can be performed using the Remote Authentication Dial-In User Service (RADIUS) or Diameter protocol standard for mobile devices, Wireless Roaming Intermediary Exchange (WRIX), or another standard for access, authorization, and accounting to keep track of usage by mobile devices.

The usage record may also include usage data in the form of numbers of sent and received data bytes, time duration of the connection, and/or any other measure of use. The usage data may also include information about the application(s) that were using the connection, websites or other resources that were accessed by the application(s) during use, and/or parameters of the connectivity service, such as the connection speed, jitter, latency, and/or other performance characteristics. The usage data for alternative network 160 may be collected by UE 170 (e.g., using accounting engine 140E), and communicated to BX platform 110 to be used for payment and billing (e.g., to sponsors of wireless connectivity).

In an embodiment, the operating system (e.g., Android™, iOS™, Microsoft Windows™, etc.) in UE 170 enables use of connections to alternative network 160 by any application and regardless of the websites or resources that are accessed. In this case, UE 170 may execute a specific browser that is controlled by or interfaced with accounting engine 140 to control and limit the resources that can be accessed. The browser may also include or be interfaced with a module that keeps track of the resources accessed (e.g., websites visited) and stores the number of bytes (or other measure) used for each resource accessed. This information can then later be used by accounting engine 140 to allocate usage per resource. In this manner, third parties (e.g., gaming providers), web stores, or content providers can sponsor or provide end users with free or reduced-cost access to their products and services on the web. The tracking may cover any and all available access points and networks, and the stored usage data can be used by BX platform 110 to accumulate the costs to the sponsors according to the sponsorship arrangements.

BX platform 110 may collect other statistics from UEs 170, such as the location of each UE 170, and the signal quality, throughput, speed, or availability of access points to home network 150 (e.g., cell tower identifiers) and/or alternative network 160 at each location and/or at specific times. BX platform 110 may use these statistics to compile useful information about the quality of connections in various locations and/or at specific times, and infer the need for data capacity or report time-of-use data and historical trends. Such reports could be sold to wireless network operators, or made available (possibly for a fee or in the form of a marketing campaign) to owners of access points of alternative network 160, potential future owners of access points of alternative network 160, or residents or owners of buildings and other structures in the vicinity of each location for which usage data has been collected. The information from the reports could be used by the operators and owners to make decisions about pricing or adding capacity in the form of registering existing access points with BX platform 110, installing new access points, and/or adding new alternative networks. These actions would provide an opportunity to the owners of buildings or access points to participate in the bandwidth exchange market.

In an embodiment, selection engine 130 may use several different radio connections simultaneously. The connections may be selected individually for different applications running on UE 170 or may be aggregated to provide a higher total data transmission capability for a single application. In other words, UE 170 can “pool” resources to increase the overall data transmission speed.

Selection engine 130 may use a combination of information to implement the rules and policies 132 for selecting connectivity. For example, selection engine 130 may be aware of the connections provided directly by the wireless operator using home network 150 and may be familiar with the connectivity through access points that have been configured for a given UE 170 by the end user (e.g., access points at the user's home, office, and/or other locations where free connectivity is available to the end user). However, in BX platform 110, real-time information about connectivity is available from proposal engines 120D residing in third-party access points of alternative network 160, or elsewhere in alternative network 160 at a location from which it can be accessed by selection engine 120. In order to participate in providing connectivity through alternative network 160, each access point must have a proposal engine 120 or provide a reference to a proposal engine 120.

1.1.3 Accounting Engine

Regardless of the level of sophistication supported by proposal engines 120 and selection engines 130, over time, each UE 170 will use connections through different access points. In order to keep track of the actual usage of each connection, and to provide information for compensation and settlements within the bandwidth exchange market, each UE 170 is covered by a local or server-based (e.g., cloud-based) accounting engine 140.

In an embodiment, accounting engine 140 keeps track of the usage of connections by UE 170 and reports it to platform 110. Specifically, accounting engine 140 keeps track of the usage of alternative network connections by each UE 170, as well as the specific terms and conditions 122 established between the proposal engine 120 and selection engine 130 for each specific usage of alternative network connections by the UE 170. Accounting engine 140 collects and provides this data to platform 110, which utilizes the data to implement the micro-commerce and reward and incentivize all participants in the bandwidth exchange market.

As a minimum condition for participating in the bandwidth exchange market, each UE 170 may be required to execute an accounting engine 140 or be covered by at least one accounting engine 140 associated with the alternative network. In a split implementation, accounting engine 140 may comprise one module executing on UE 170 and another module executing on a server of the alternative network access provider. In this case, platform 110 may receive usage reports from the module on UE 170 and/or the module on the server of the alternative network access provider. In at least some instances, platform 110 will receive usage reports from both modules, which provides an opportunity to audit the usage reports from both UE 170 and the alternative network access provider to ensure that the usage is being accurately reported.

To the extent the capability is available, access points may include an accounting engine 140D that can collect information about the usage of data capacity by each UE 170. If such records are collected and made available to BX platform 110, they may be recompiled and used to verify the usage records provided by the accounting engines 140E in UEs 170. In an embodiment, BX platform 110 automatically logs into the administrator's interface of registered access points (e.g., using credentials provided by the access point owners during initial registration with BX platform 110), in order to retrieve usage reports that indicate the usage of connectivity by each participating UE 170. This capability may be utilized in at least a subset of access points to provide a useful auditing function and ensure that the reporting by UEs 170 is accurate.

1.1.4 Bandwidth Exchange Platform

In an embodiment, BX platform 110 manages all the information for implementing the micro-commerce between home network providers, alternative network access providers, owners of access points, and the end users of wireless devices. Management of the exchange may include: managing messaging and/or instructions for transferring or swapping UEs 170 between home network 150 and alternative network 160; managing terms and conditions 122; managing usage records 142; and providing billing and payment services to all parties. As discussed elsewhere herein, BX platform 110 may be implemented as software modules executing one or more dedicated servers or in the cloud.

1.2. Example Network Coverage

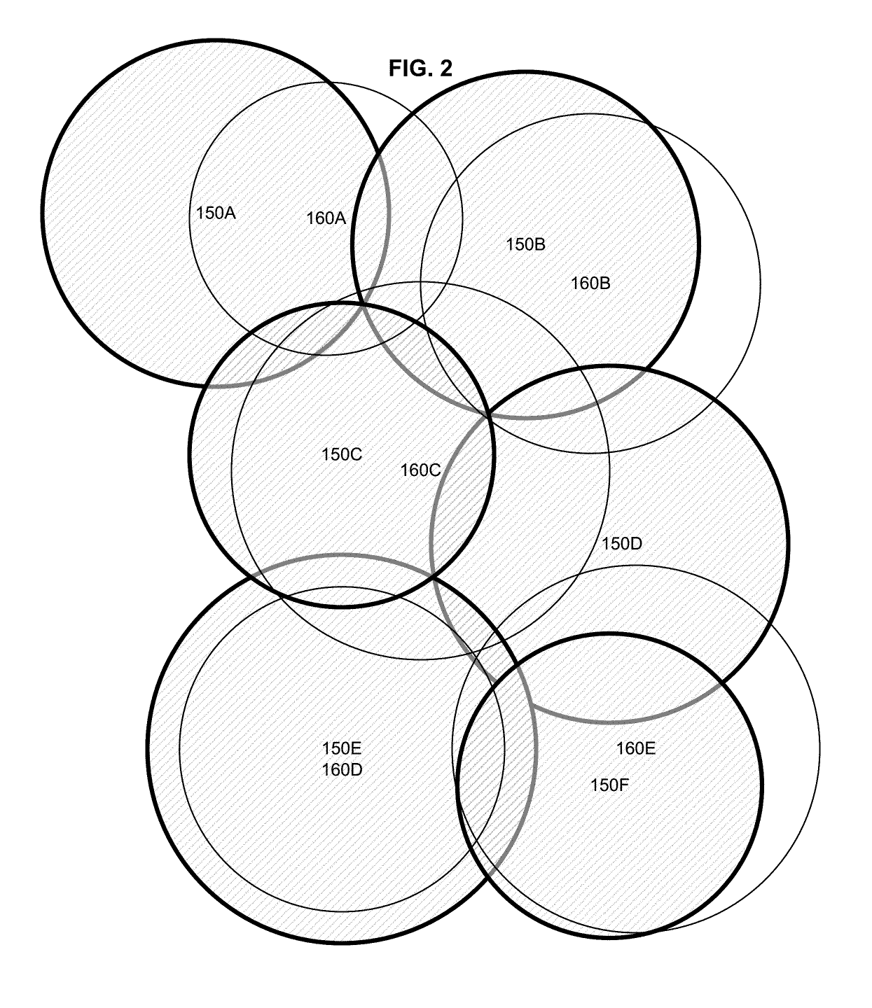

FIG. 2 illustrates an example of overlapping coverage for a geographic area serviced by access points of both a home and alternative network, according to an embodiment. As illustrated, the geographic area may comprise a plurality of access points (e.g., cellular base stations) of home network 150, as well as a plurality of access points (e.g., cellular base stations or Wi-Fi™ access points) of alternative network 160. The coverage area of any given access point may overlap the coverage area of one or more other access points, such that a given region may be serviced by multiple access points of home network 150, multiple access points of alternative network 160, or one or more access points of home network 150 and one or more access points of alternative network 160. In some cases, an access point of home network 150 may be collocated with an access point of alternative network 160 (e.g., as illustrated by 150E and 160D).

As used herein, the term “sector” refers to a coverage area provided by an access point of home network 150 and alternative network 160. The access point may be a cellular base station (e.g., LTE eNodeB), a non-cellular access point (e.g., a Wi-Fi™ access point), or any other type of device that provides wireless access to a network. A single access point may provide a single sector of a network (e.g., using unidirectional, multi-directional, or omnidirectional antenna(s) to create a single sector) or a plurality of different sectors of a network (e.g., using a plurality of sector antennas to create a plurality of sectors).

1.3. Example Processing Device

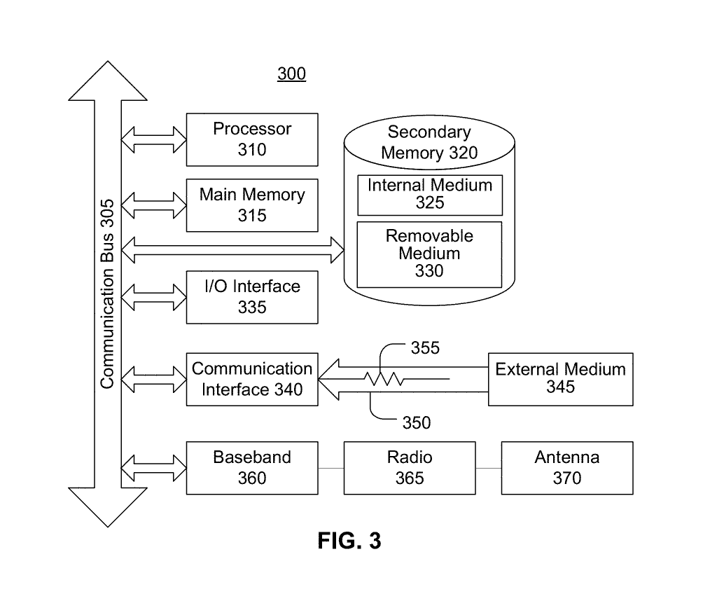

FIG. 3 illustrates an example wired or wireless system 300 that may be used in connection with various embodiments described herein. For example system 300 may be used as or in conjunction with one or more of the mechanisms, processes, methods, or functions (e.g., to store and/or execute one or more software modules) described herein, and may represent components of platform 110, access points of home network 150 and/or alternative network 160, UEs 170, and/or other processing devices described herein. System 300 can be a wireless device, a server, a conventional personal computer, or any other processor-enabled device that is capable of wired or wireless data communication. Other computer systems and/or architectures may be also used, as will be clear to those skilled in the art.

System 300 preferably includes one or more processors, such as processor 310. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 310. Examples of processors which may be used with system 300 include, without limitation, the Pentium® processor, Core i7® processor, and Xeon® processor, all of which are available from Intel Corporation of Santa Clara, Calif.

Processor 310 is preferably connected to a communication bus 305. Communication bus 305 may include a data channel for facilitating information transfer between storage and other peripheral components of system 300. Furthermore, communication bus 305 may provide a set of signals used for communication with processor 310, including a data bus, address bus, and control bus (not shown). Communication bus 305 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPM), IEEE 696/S-100, and the like.

System 300 preferably includes a main memory 315 and may also include a secondary memory 320. Main memory 315 provides storage of instructions and data for programs executing on processor 310, such as one or more of the functions and/or modules discussed above. It should be understood that programs stored in the memory and executed by processor 310 may be written and/or compiled according to any suitable language, including without limitation C/C++, Java, JavaScript, Perl, Visual Basic, .NET, and the like. Main memory 315 is typically semiconductor-based memory such as dynamic random-access memory (DRAM) and/or static random-access memory (SRAM). Other semiconductor-based memory types include, for example, synchronous dynamic random-access memory (SDRAM), Rambus dynamic random-access memory (RDRAM), ferroelectric random-access memory (FRAM), and the like, including read-only memory (ROM).

Secondary memory 320 may optionally include an internal memory 325 and/or a removable medium 330. Removable medium 330 is read from and/or written to in any well-known manner. Removable storage medium 330 may be, for example, a magnetic tape drive, a compact disc (CD) drive, a digital versatile disc (DVD) drive, other optical drive, a flash memory drive, etc.

Removable storage medium 330 is a non-transitory computer-readable medium having stored thereon computer-executable code (e.g., disclosed software modules) and/or data. The computer software or data stored on removable storage medium 330 is read into system 300 for execution by processor 310.

In alternative embodiments, secondary memory 320 may include other similar means for allowing computer programs or other data or instructions to be loaded into system 300. Such means may include, for example, an external storage medium 345 and a communication interface 340, which allows software and data to be transferred from external storage medium 345 to system 300. Examples of external storage medium 345 may include an external hard disk drive, an external optical drive, an external magneto-optical drive, etc. Other examples of secondary memory 320 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, system 300 may include a communication interface 340. Communication interface 340 allows software and data to be transferred between system 300 and external devices (e.g. printers), networks, or other information sources. For example, computer software or executable code may be transferred to system 300 from a network server via communication interface 340. Examples of communication interface 340 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 300 with a network or another computing device. Communication interface 340 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 340 are generally in the form of electrical communication signals 355. These signals 355 may be provided to communication interface 340 via a communication channel 350. In an embodiment, communication channel 350 may be a wired or wireless network, or any variety of other communication links. Communication channel 350 carries signals 355 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs, such as the disclosed application, or software modules) is stored in main memory 315 and/or the secondary memory 320. Computer programs can also be received via communication interface 340 and stored in main memory 315 and/or secondary memory 320. Such computer programs, when executed, enable system 300 to perform the various functions of the disclosed embodiments as described elsewhere herein.

In this description, the term “computer-readable medium” is used to refer to any non-transitory computer-readable storage media used to provide computer-executable code (e.g., software and computer programs) to system 300. Examples of such media include main memory 315, secondary memory 320 (including internal memory 325, removable medium 330, and external storage medium 345), and any peripheral device communicatively coupled with communication interface 340 (including a network information server or other network device). These non-transitory computer-readable mediums are means for providing executable code, programming instructions, and software to system 300.

In an embodiment that is implemented using software, the software may be stored on a computer-readable medium and loaded into system 300 by way of removable medium 330, I/O interface 335, or communication interface 340. In such an embodiment, the software is loaded into system 300 in the form of electrical communication signals 355. The software, when executed by processor 310, preferably causes processor 310 to perform the features and functions described elsewhere herein.

In an embodiment, I/O interface 335 provides an interface between one or more components of system 300 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

System 300 may also include optional wireless communication components that facilitate wireless communication over a voice network and/or a data network. The wireless communication components comprise an antenna system 370, a radio system 365, and a baseband system 360. In system 300, radio frequency (RF) signals are transmitted and received over the air by antenna system 370 under the management of radio system 365.

In one embodiment, antenna system 370 may comprise one or more antennae and one or more multiplexors (not shown) that perform a switching function to provide antenna system 370 with transmit and receive signal paths. In the receive path, received RF signals can be coupled from a multiplexor to a low noise amplifier (not shown) that amplifies the received RF signal and sends the amplified signal to radio system 365.

In an alternative embodiment, radio system 365 may comprise one or more radios that are configured to communicate over various frequencies. In an embodiment, radio system 365 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 365 to baseband system 360.

If the received signal contains audio information, then baseband system 360 decodes the signal and converts it to an analog signal. Then the signal is amplified and sent to a speaker. Baseband system 360 also receives analog audio signals from a microphone. These analog audio signals are converted to digital signals and encoded by baseband system 360. Baseband system 360 also codes the digital signals for transmission and generates a baseband transmit audio signal that is routed to the modulator portion of radio system 365. The modulator mixes the baseband transmit audio signal with an RF carrier signal generating an RF transmit signal that is routed to antenna system 370 and may pass through a power amplifier (not shown). The power amplifier amplifies the RF transmit signal and routes it to antenna system 370, where the signal is switched to the antenna port for transmission.

Baseband system 360 is also communicatively coupled with processor 310, which may be a central processing unit (CPU). Processor 310 has access to data storage areas 315 and 320. Processor 310 is preferably configured to execute instructions (i.e., computer programs, such as the disclosed application, or software modules) that can be stored in main memory 315 or secondary memory 320. Computer programs can also be received from baseband processor 360 and stored in main memory 310 or in secondary memory 320, or executed upon receipt. Such computer programs, when executed, enable system 300 to perform the various functions of the disclosed embodiments. For example, data storage areas 315 or 320 may include various software modules.

2. Process Overview

Embodiments of processes for alternative network access will now be described in detail. It should be understood that the described processes may be embodied in one or more software modules that are executed by one or more hardware processors (e.g., server application, client application, and/or a distributed application comprising a combination of server and client applications), which may be executed wholly by processor(s) of platform 110, wholly by processors of an access point or a server or gateway within home network 150 and/or alternative network 160, wholly by processor(s) of UEs 170, or may be distributed across any combination of two or more of these devices. The described process may be implemented as instructions represented in source code, object code, and/or machine code. These instructions may be executed directly by the hardware processor(s), or alternatively, may be executed by a virtual machine operating between the object code and the hardware processors.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

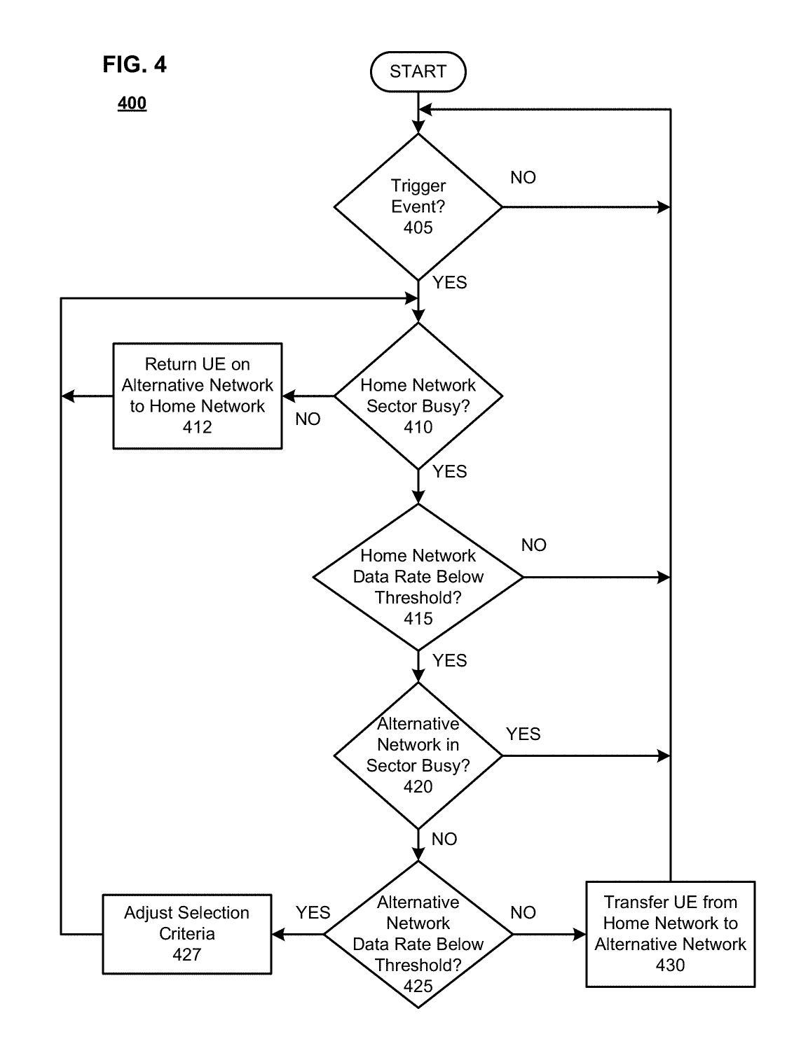

FIG. 4 illustrates an example selection process 400 that may be implemented by selection engine 130 (e.g., selection engine 130A on BX platform 110), according to an embodiment. Selection process 400 may be used as a decision mechanism for determining when a UE 170 should be offloaded to alternative network 160 when alternative network 160 is associated with access points that provide overlapping coverage with the access points of home network 150 (e.g., as illustrated in FIG. 2), i.e., sectors of alternative network 160 overlap with sectors of home network 150. While process 400 is illustrated with a certain arrangement of steps, process 400 may be implemented with fewer, more, or different steps and a different arrangement or ordering of steps (e.g., steps 415 and/or 425 may be omitted or collapsed into steps 410 and 420, respectively). Furthermore, while process 400 will be described under the assumption that there is only one available alternative network 160, process 400 may be applied to any number of different alternative networks (e.g., by executing process 400 or portions of process 400 for each alternative network).

In step 405, selection engine 130 determines whether a trigger event has occurred. In an embodiment, process 400 is triggered or otherwise initiated as a result of one or more measurement reports received from home network 150 to BX platform 110. Thus, home network 150 may directly trigger selection process 400. Alternatively, a UE 170 may trigger the selection process 400 in a sector of home network 150 by sending one or more measurement reports to BX platform 110.

Each measurement report may comprise performance characteristics (e.g., data rate/speed or throughput, traffic load, latency of transmission or connection, SINR, SNR, RSSI, and/or any other relevant measurements) from a sector (e.g., cellular network sector) of home network 150. Network management system 152A of home network 150 may receive one or more measurements reports from an access point (e.g., a cellular base station, such as an LTE eNodeB, providing the sector of home network 150), or UEs 170 connected to the sector of home network 150. A measurement report, received by BX platform 110, may comprise a historical data profile or pattern, based on measurement reports collected by the network management system 152A of home network 150, and may be stored in BX platform 110 in association with the sector.

In an embodiment, each measurement report for a sector of home network 150 may comprise performance indicators that are associated with the downlink and/or uplink resource usage. Such performance indicators may include, without limitation: PRB usage (e.g., in percentage of PRBs used, number of PRBs used, or both); average PRB usage (e.g., in percentage of PRBs used, number of PRBs used, or both); busy-hour PRB usage (e.g., average PRBs used during a sixty-minute period centered around a peak load point) or highest hourly PRB usage (e.g., in percentage of PRBs used, number of PRBs used, or both); PRBs allocated for or assigned to the UEs; measurements related to radio resource control; measurements related to network element resource utilization; measurements related to data radio bearer; measurements related to handover; measurements related to data rate/speed; measurements related to encoding rate; measurements related to average data rate or throughput per UE 170; and/or measurements related to QoS. It should be understood that a measurement report may represent performance indicator(s) for the whole sector or one or more carriers of the sector.

Each measurement report for a UE 170 may comprise one or more identifiers of the UE 170 (e.g., MSISDN, IMEI) or the smart card in the UE 170 (e.g., IMSI, ICCID) and one or more performance indicators. These performance indicators may include, without limitation: SNR; SINR; data rate/speed or throughput; channel quality indicator (CQI); received signal strength indicator (RSSI); reference signal received power (RSRP); reference signal received quality (RSRQ); modulation and coding scheme (MCS); and/or latency. The measurement report may also include network or network element identifiers within the vicinity of UE 170, such as a sector identifier, cell identifier, physical cell identifier (PCI), mobile network code (MNC), mobile country code (MCC), SSID, BSSID, MAC address, and/or any other unique identifiers.

In another embodiment, the trigger event in step 405 may be something other than the reception of measurement report(s). In an embodiment, the trigger event may be a time of day, day of week, day of month, etc. For example, BX platform 110 may determine that, based on historical data profiles of home network 150 or of one or more UE(s) 170, the sector of home network 150 is experiencing its busy hour, and therefore, initiate selection process 400 to offload one or more UEs 170 to access point(s) of alternative network 160 whose coverage overlap the sector of home network 150. In other words, process 400 may be triggered in step 405 for a given sector at the beginning of each busy hour for that sector.

If a trigger event has not occurred (i.e., “NO” in step 405), process 400 continues to wait for a trigger event. Otherwise, if a trigger event has occurred (i.e., “YES” in step 405), process 400 proceeds to step 410.

In step, 410, after a trigger event has occurred (e.g., receiving one or more messages with one or more measurement reports) for a sector of home network 150, an application executing on BX platform 110 may determine if the sector is busy (e.g., based on the measurement report(s)). For example, BX platform 110 may determine that the sector is busy if the current time is within the busy hour for the sector, resources are being over-utilized (e.g., one or more performance characteristics of the sector are below a respective threshold), the sector is too busy to serve a specific UE (e.g., one or more performance characteristics of the specific UE are below a respective threshold), and/or the like. As further examples, the sector may be determined to be busy when average PRB usage is above a threshold (e.g., a percentage of PRBs used is above 50%), when busy-hour PRB usage is above a threshold (e.g., average percentage of PRB usage in four fifteen-minute increments, or average PRBs used during a sixty-minute period, is above 80%), when busy-hour downlink or uplink PRB usage is above a threshold, when data rate or speed per UE or user is below a threshold (e.g., average data rate or speed per UE is below 5 Mbps), and/or when latency or round-trip delay time (e.g., in milliseconds) is above a threshold. Step 410 may involve determining whether one sector is busy, whether a plurality of sectors are individually or collectively busy, whether a particular access point (which may provide one or more sectors) is busy, and/or whether a plurality of access points (each of which may provide one or more sectors) are busy.

Alternatively, an application executing on a UE 170 within the sector of home network 150 may determine whether or not home network 150 is busy. In this case, BX platform 110 may initiate the offloading process, in response to message(s) from UE 170, without having to request measurement report(s) from home network 150. As another alternative, the determination process in step 410 may be split and/or coordinated between BX platform 110 and UE 170. In any case, if the sector is determined to be busy (i.e., “YES” in step 410), process 400 proceeds to step 415. Otherwise, if the sector is not determined to be busy (i.e., “NO” in step 410), process 400 proceeds to step 412.

In step 412, since the sector of home network 150 is not busy, if any UEs within the sector are currently offloaded to alternative network 160, for example, via access point(s) (e.g., a Wi-Fi™ access point, cellular base station such as an LTE eNodeB) of alternative network 160 whose coverage overlap the coverage of the sector of home network 150, process 400 returns at least one of those UEs to home network 150, and then returns to step 410. Step 412 may comprise BX platform 110 initiating an instruction to return a UE 170, that is currently connected to alternative network 160 within the sector, to connect to home network 150. Once UE 170 has connected to home network 150, it may then terminate its connection to alternative network 160. In an embodiment, BX platform 110 may return UEs 170 within the sector to home network 150, incrementally (e.g., one at a time), until either no UEs 170 within the sector are connected to alternative network 160 or the sector of home network 150 becomes busy or within a threshold of being busy.

In step 415, if the sector of home network 150 is busy, process 400 may further determine whether the data rate/speed or throughput associated with UEs 170, connected to the sector of home network 150, is above or below a threshold. Network management system 152A of home network 150 may receive measurement reports from an access point (e.g., a cellular base station, such as an LTE eNodeB) providing the sector of home network 150, or UEs 170 connected to the sector of home network 150. BX platform 110 may also directly receive the data rate or throughput associated with UEs 170 connected to the sector of home network 150. In an embodiment, the data rate or throughput for UEs 170, connected to the sector of home network 150, may be derived by other performance indicators, such as SNR, SINR, RSRQ, RSRP, RSSI, CQI, or MCS. These performance indicators may be used to determine if the data rate or throughput, associated with a UE 170, is above or below a threshold. For example, a low SNR or SINR may indicate that the data rate or throughput, associated with the UE 170, is below a threshold. In another example, if the MCS indicates that a low-order modulation scheme is used (e.g., quadrature phase-shift keying (QPSK)), that may be an indication that the data rate or throughput, associated with the UE 170, is below a threshold. In another embodiment, the determination in step 415 may be based on an empirical data relationship between PRB usage and UE data rates or throughputs (e.g., in Mbps) that has been previously received or collected and/or stored in BX platform 110. For example, the determination in step 415 may be based on a data relationship, between an average data rate per UE and downlink PRB usage for a given LTE channel bandwidth during the busy hour. If the data rate is not below the threshold (i.e., “NO” in step 415), process 400 may return to step 405 to wait for another trigger event. Otherwise, if the data rate is below the threshold (i.e., “YES” in step 415), process 400 may proceed to step 420 to determine whether or not it would be appropriate to instruct one or more UEs 170, connected to the sector of home network 150, to offload to or otherwise transfer to or roam on alternative network 160. As an alternative, a performance characteristic other than data rate (e.g., encoding rate, signal strength, SINR, latency) may be used for the determination in step 415.

In step 420, an application executing on BX platform 110 may determine if access point(s) of alternative network 160 (e.g., Wi-Fi™ access point or cellular base station, such as LTE eNodeB), having overlapping coverage with the given sector of home network 150, are busy. This determination may comprise BX platform 110 requesting, receiving, and/or storing one or more measurement reports for alternative network 160 from network management system 152B of alternative network 160. These one or more measurement reports may represent the measurement reports for one or more sectors of alternative network 160 which overlap with the sector of home network 150 that was determined to be busy in step 410. It should be understood that a sector of home network 150 may overlap with multiple sectors of alternative network 160, and vice versa. The measurement report may comprise a historical data profile or pattern for the sector(s) of alternative network 160, overlapping the busy sector of home network 150, that has been received from network management system 152B of alternative network 160, or that has been previously received or collected and stored in BX platform 110. If alternative network 160 in the sector of home network 150 is determined to be busy (i.e., “YES” in step 420), process 400 returns to step 405 to await another trigger event. Otherwise, if alternative network 160 in the sector of home network 150 is not determined to be busy (i.e., “NO” in step 420), process 400 proceeds to step 425. Step 420 may involve determining whether one sector is busy, whether a plurality of sectors are individually or collectively busy, whether a particular access point (which may provide one or more sectors) is busy, and/or whether a plurality of access points (each of which may provide one or more sectors) are busy.

In step 425, if alternative network 160 in the sector of home network 150 is not determined to be busy, process 400 may further determine whether the data rate or throughput associated with UEs 170 (e.g., average data rate across the UEs), connected to sector(s) of alternative network 160 overlapping the sector of home network 150, is above or below a threshold. Network management system 152B of alternative network 160 may receive measurement reports from access point(s) (e.g., Wi-Fi™ access point or cellular base station, such as LTE eNodeB) of alternative network 160 providing overlapping coverage with the sector of home network 150, or UEs 170 connected to alternative network 160 within a coverage area of the sector of home network 150. BX platform 110 may also directly receive the data rate or throughput associated with UEs 170 connected to alternative network 160 within a coverage area of the sector of home network 150. If the data rate (e.g., average data rate or throughput across UEs 170 connected to alternative network 160 within the coverage area of the sector of home network 150) is not below the threshold (i.e., “NO” in step 425), process 400 may proceed to step 430. Otherwise, if the data rate is below the threshold (i.e., “YES” in step 425), process 400 may proceed to step 427. As an alternative, a performance characteristic other than data rate (e.g., encoding rate, signal strength, SINR, latency) may be used for the determination in step 425.

In step 427, the selection criteria for the selection process 400 may be adjusted. Specifically, in the event that there are no offload opportunities (i.e., “YES” in step 425) that fulfill the current criteria (e.g., data rates, PRB usage, etc.) and the sector of home network 150 is still busy (i.e., “YES” in step 410), process 400 will adjust (e.g., loosen) the criteria for one or more of steps 410-425 (e.g., raise the threshold for the data rate that defines the boundary between the busy and non-busy states in step 425). After adjustment of the selection criteria, process 400 then returns to step 410. Step 427 may be performed, over multiple iterations of process 400, until a balance is found between the load of UEs 170 that have been offloaded to alternative network 160 and the load of UEs 170 that remain on home network 150. A balance may be reached when the average data rates in home network 150 and the average data rates in alternative network 160 match or are substantially similar (e.g., within a predetermined range of each other). Alternatively, the balance may be reached when some other performance characteristic, or combination of performance characteristics, match or are substantially similar.

In step 430, since one or more sectors of alternative network 160, overlapping the sector of home network 150, have a sufficient data rate, at least one UE 170, which is currently connected to home network 150 and does not have a sufficient data rate, may be transferred from home network 150 to alternative network 160, and process 400 may return to step 405 to await another trigger event. Step 430 may comprise BX platform 110 selecting one or more UEs 170, connected to the sector of home network 150, and initiating or otherwise issuing an instruction or other command to offload each selected UE 170 to connect to a sector of alternative network 160 (i.e., via an access point of alternative network 160) that overlaps the sector of home network 150 in a coverage area that includes the selected UE 170. Once connected to a sector of alternative network 160, each selected UE 170 may then terminate its connection with the sector of home network 150. In this manner, one or more UEs 170 are offloaded from the busy sector of home network 150 to a non-busy sector of alternative network 160.

BX platform 110 may select UEs 170 to offload from home network 150 to alternative network 160, for example, by selecting a percentage of UEs 170 connected to the sector of home network 150, a set of UEs 170 with the lowest data rates, a set of UEs that are closest to an edge of the sector (e.g., at the farthest distance from the access point providing the sector) of home network 150 (e.g., as determined by low SNR or SINR), inside a building, and/or the like. In an embodiment, network management system 152A of home network 150 identifies UEs 170 with data rates below a threshold, and BX platform 110 selects one or more of these identified UEs 170 to be offloaded to alternative network 160. Alternatively, network management system 152A may perform the selection of UEs 170 to be offloaded, instead of BX platform 110. For example, network management system 152A of home network 150 may perform steps 405, 410, and 415 of process 400, and, when determining “YES” in each step, trigger BX platform 110 (e.g., via messaging) to perform steps 420-430.

In an embodiment, prior to offloading each selection UE 170, BX platform 110 may request a status report from that UE 170. The status report may indicate whether or not the UE 170 is in the middle of a data or voice session (e.g., connected mode, Radio Resource Control (RRC) connected). If the status report indicates that the UE 170 is in the middle of such a session, BX platform 110 may postpone the offloading instruction based on a set of rules and/or policies (e.g., rules and policies 132A). This set of rules and/or policies may identify one or more conditions (e.g., the existence of a data or voice session) under which an offload to alternative network 160 should be postponed and/or one or more conditions under which an ongoing postponement should end (e.g., the termination of an existing data or voice session, the expiration of a set time period following the postponement decision, etc.). Alternatively, a UE 170 may locally determine to postpone being offloaded when the UE 170 is in the middle of a data or voice session. In this case, an application (e.g., the BX application), being executed by UE 170, may postpone the offload (e.g., after receiving an instruction to offload from BX platform 110) based on a set of rules and/or policies (e.g., rules and policies 132E). This set of rules and/or policies may identify one or more conditions (e.g., the existence of a data or voice session) under which an offload to alternative network 160 should be postponed and/or one or more conditions under which the postponement should end (e.g., the termination of a previous data or voice session, the expiration of a set time period following a postponement decision, etc.). In yet another alternative, the postponement decision may be implemented by mutual decision, or a combination of determinations, made by both BX platform 110 and the BX application executing on UE 170.

In an embodiment, the instruction, initialized from BX platform 110 (e.g., transmitted or caused to be transmitted) to a UE 170, to offload the UE 170 from home network 150 to alternative network 160, is facilitated by a change or switch international mobile subscriber identity (IMSI) command or other instruction message from BX platform 110 to OTA server 156A of home network 150. The change IMSI command may be sent from BX platform 110 to OTA server 156A using one or more API commands over an IP-based virtual private network (VPN). The change IMSI command from BX platform 110 to OTA server 156A may include one or more identifiers, such as an Integrated-Circuit Card Identifier (ICCID), an IMSI, a Mobile Station International Subscriber Directory Number (MSISDN), and/or an International Mobile Equipment Identity (IMEI). Upon receiving the change IMSI command from BX platform 110, OTA server 156A of home network 150 may invoke a change of the IMSI on the smart card of the UE 170 to be offloaded. The smart card may be a Subscriber Identity Module (SIM) card, a Universal SIM (USIM) card, or an electronic SIM (eSIM). OTA server 156A may facilitate the change of the IMSI on the smart card of the UE 170 via a data communication network (e.g., via IP-based data communication, such as HTTPS). Alternatively, OTA server 156A may facilitate the change of the IMSI on the smart card via a binary Short Message Service (SMS) over a data communication network or a signaling network.

An application or applet on the smart card of UE 170 may invoke the change of the IMSI to the desired alternative network 160 (e.g., public land mobile network (PLMN)), and trigger a refresh of the UE 170. In an embodiment, the refresh trigger is invoked by an application or applet command on the smart card. The smart card may be equipped with multi-IMSI functionality or multi-IMSI profiles, and switch the IMSI once the change or switch IMSI command is received from OTA server 156A of home network 150. Accordingly, the UE 170 will register with the access point and/or core network of alternative network 160 and authenticate with home network 150.

In another embodiment, the instruction, initialized from BX platform 110 to a UE 170, to offload the UE 170 from home network 150 to alternative network 160 may be facilitated by a directed UE-to-UE connection or D2D connection, for example, between UE 170B and 170A in FIG. 1C. The direct connection between UEs can be implemented using one of several technologies, such as LTE Direct (LTED), Wi-Fi™ Direct, Bluetooth™, or Bluetooth™ Low Energy. In an embodiment, BX platform 110 may initialize an instruction (e.g., directly, by sending a message comprising a command, request, or directive, or, indirectly, by instructing network management system 152A or other component of home network 150 to send such a message) to a UE 170B, which is subscribed to or “camped on” home network 150, to listen to beacon (e.g., broadcast) messages for proximal discovery and connection information. The beacon messages may include: SSID, BSSID, MAC address, location information, UE battery status (e.g., percentage of total battery power remaining), available date rate or throughput, mobile network code (MNC), mobile country code (MCC) or any other relevant information. For LTED, a licensed frequency band (e.g., uplink frequency band) of alternative network 160 may be used for the proximal discovery communications between UE 170B and UE 170A. For Wi-Fi™ direct and Bluetooth™, unlicensed frequency band may be used for the proximal discovery communications between UE 170B and UE 170A. Once a session between UE 170B and UE 170A has been agreed upon (e.g., based on rules and policies 132E of UE 170B and/or rules and policies 132F of UE 170A) and a communication link established, UE 170B, which is subscribed to home network 150, may transfer (or offload) its data communications to the connection with UE 170A, which then relays those data communications between UE 170B and alternative network 160. In one embodiment, prior to establishing a communication link between UE 170B and UE 170A, the agreement between the UEs may need to be confirmed or otherwise approved by BX platform 110. In another embodiment, the agreement may be mutually confirmed or otherwise approved by both UE 170B and BX platform 110.

After one or more UEs 170 have been offloaded to alternative network 160, BX platform 110 may send requests (e.g., periodically) for measurement reports to each offloaded UE 170, and determine whether or not the offloaded UE(s) 170 should remain connected to alternative network 160 based on the measurement reports (e.g., based on whether or not the data rate or connection speed remains above a threshold) or based on a time period. If BX platform 110 determines that an offloaded UE 170 should not remain connected to alternative network 160, BX platform may transmit an instruction to return the offloaded UE 170 to home network 150.

Notably, the order of steps in selection process 400 may be selected based on the resources needed for each successive step. Specifically, the number of devices involved in each step is reduced in the successive step. Thus, it is advantageous to place the steps that cause the smallest resource consumption early in the order of steps (i.e., when more devices are involved). In an embodiment, the primary consideration for measuring resource consumption may be the battery life consumed by a step.

For example, step 410 determines whether or not a sector of home network 150 is currently busy. In this step, UEs 170 in non-busy sectors will not consume any resources for process 400. As discussed elsewhere herein, the determination about whether the sector is busy or not may come from a real-time indicator of a network load (e.g., from network management system 152A) or be based on historical data (e.g., stored in network management system 152A or BX platform 110).

Step 415 then further narrows the number of UEs 170 involved by filtering out UEs 170 that are not experiencing low data rates, thereby leaving, for further consideration, only those UEs 170 causing a high load in the busy sector. Obtaining the data rates or other performance characteristics (e.g., signal strength, SINR) of UEs 170 is performed locally by the UEs 170 and does not consume much power.

Steps 420 and 425 may require activation of a radio system within each UE 170 involved. For example, each UE 170 may need to scan frequencies in its environments to determine the identifiers (e.g., sector identifier, cell identifier, PCI, SSID) of visible access points, in order to determine whether or not any of the visible access points are for an alternative network 160 to which the UE 170 may be offloaded. Each UE 170 may also use its radio system to measure the performance characteristics (e.g., data rate, SNR, SINR, RSSI, etc.) of one or more of the visible access points. The determination in step 430 of which UEs 170 should be offloaded to alternative network 160 will depend on these results obtained from the radio systems of UEs 170. The objective is to find the best opportunities from the perspective of quality of the utilized network, opportunity cost of the utilized network, quality (e.g., speed) of the connection, and/or the like.

By properly ordering the steps, only a small number of UEs 170 will be involved in the most resource-intensive steps of process 400 (e.g., steps 420 and 425, which require the most battery consumption). In this manner, relief to the busy sectors is achieved in the most effective way and with the smallest number of UEs 170 being offloaded to roam on alternative network 160, which may be an objective of the participating mobile service provider(s) of home network 150.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method comprising using at least one hardware processor of a remote server to:
determine whether a sector of a home network is busy based on one or more measurement reports associated with the sector, wherein the one or more measurement reports indicate at least one performance characteristic of the sector;
when the sector of the home network is determined to be busy, determine whether one or more sectors of an alternative network, which overlap with the sector of the home network, are busy based on at least one performance characteristic of the one or more sectors of the alternative network; and,
when the sector of the home network is determined to be busy and the one or more sectors of the alternative network are not determined to be busy, initiate transmission of an instruction to offload one or more wireless devices, connected to the home network within the sector, to at least one of the one or more sectors of the alternative network.

2. The method of claim 1, wherein the at least one performance characteristic of the sector comprises an average data rate or throughput per wireless device connected to the home network within the sector, and wherein the sector of the home network is determined to be busy when the average data rate or throughput per wireless device is below a threshold.

3. The method of claim 1, wherein the at least one performance characteristic of the sector comprises a percentage of downlink physical resource block usage, and wherein the sector of the home network is determined to be busy when the percentage of downlink physical resource block usage is above a threshold.

4. The method of claim 1, wherein the at least one performance characteristic of the sector comprises a profile for the entire sector of the home network.

5. The method of claim 4, wherein the profile comprises one or both of a percentage and number of downlink physical resource block usages for the sector.

6. The method of claim 5, wherein the percentage comprises an average percentage of physical resource block usages for the sector and the number comprises an average number of physical resource block usages for the sector.

7. The method of claim 4, wherein the profile comprises one or both of a percentage and number of downlink busy-hour physical resource block usages for the sector.

8. The method of claim 4, wherein the profile comprises an average data rate or throughput per wireless device connected to the home network within the sector.

9. The method of claim 1, wherein the at least one performance characteristic of the sector comprises a performance characteristic measured by one or more wireless devices connected to the home network within the sector.

10. The method of claim 1, wherein the at least one performance characteristic of the sector comprises a percentage of downlink busy-hour physical resource block usage, and wherein the sector of the home network is determined to be busy when the percentage of downlink busy hour physical resource block usage is above a threshold.

11. The method of claim 1, wherein the determination of whether a sector of a home network is busy is performed in response to a trigger event.

12. The method of claim 11, wherein the trigger event comprises receiving the one or more measurement reports associated with the sector.

13. The method of claim 11, wherein the trigger event comprises a start of a time period.

14. The method of claim 13, wherein the time period is a busy hour for the sector of the home network, wherein the busy hour represents a sixty-minute period centered around a peak load point for traffic in the sector of the home network.

15. The method of claim 1, further comprising using the at least one hardware processor of the remote server to, when the sector of the home network is not determined to be busy, initiate transmission of an instruction to return one or more wireless devices, connected to at least one sector of the alternative network, which overlaps with the sector of the home network, to the home network.

16. The method of claim 1, further comprising using the at least one hardware processor of the remote server to, when the sector of the home network is determined to be busy and the one or more sectors of the alternative network are determined to be busy, loosen one or more criteria for one or both of determining whether the sector of the home network is busy and determining whether the one or more sectors of the alternative network are busy until the at least one performance characteristic of the sector of the home network and the at least one performance characteristic of the one or more sectors of the alternative network are substantially similar.

17. The method of claim 1, further comprising using the at least one hardware processor of the remote server to, when the sector of the home network is determined to be busy and the one or more sectors of the alternative network are not determined to be busy, select the one or more wireless devices, from a plurality of wireless devices connected to the home network within the sector of the home network, to offload to the at least one sector of the alternative network.

18. The method of claim 17, wherein selecting the one or more wireless devices comprises:
requesting a status report from each of the plurality of wireless devices connected to the home network within the sector of the home network;
receiving a status report from each of the plurality of wireless devices connected to the home network within the sector of the home network; and
selecting the one or more wireless devices from the plurality of wireless devices based on the received status reports.

19. The method of claim 18, wherein selecting the one or more wireless devices from the plurality of wireless devices based on the received status reports comprises not selecting at least one wireless device whose received status report indicates that the at least one wireless device is currently engaged in a data or voice session.

20. The method of claim 1, wherein initiating transmission of the instruction comprises sending a command to switch an international mobile subscriber identity (IMSI) to an over-the-air (OTA) server.

21. The method of claim 20, wherein the command to switch the IMSI invokes a change in the IMSI on a smart card in at least one of the one or more wireless devices.

22. The method of claim 21, wherein the smart card is subscriber identity module (SIM) card, a universal SIM (USIM) card, or an electronic SIM (eSIM) card.

23. The method of claim 1, wherein initiating transmission of the instruction comprises, for each of the one or more wireless devices connected to the home network within the sector, sending a command to the wireless device to scan an environment of the wireless device for one or more access points of the alternative network.

24. The method of claim 1, wherein initiating transmission of the instruction comprises, for each of the one or more wireless devices connected to the home network within the sector, sending an approval to the wireless device to connect to another wireless device that relays communications to and from the alternative network.

25. The method of claim 1, wherein the home network is a wireless cellular network and the sector of the home network is provided by a cellular base station, and wherein the alternative network is a Wi-Fi™ network and the one or more sectors of the alternative network are provided by Wi-Fi™ access points.

26. The method of claim 1, wherein the home network is a wireless cellular network and the sector of the home network is provided by a cellular base station, and wherein the alternative network is a wireless cellular network and the one or more sectors of the alternative network are provided by cellular base stations.

27. The method of claim 1, further comprising using the at least one hardware processor of the remote server to, when the sector of the home network is determined to be busy and the one or more sectors of the alternative network are not determined to be busy, select the one or more wireless devices with a low signal-to-noise ratio or a low signal-to-interference-plus-noise ratio, from a plurality of wireless devices connected to the home network within the sector of the home network, to offload to the at least one sector of the alternative network.

28. A system comprising:
at least one hardware processor; and
one or more software modules that, when executed by the at least one hardware processor,
determine whether a sector of a home network is busy based on one or more measurement reports associated with the sector, wherein the one or more measurement reports indicate at least one performance characteristic of the sector,
when the sector of the home network is determined to be busy, determine whether one or more sectors of an alternative network, which overlap with the sector of the home network, are busy based on at least one performance characteristic of the one or more sectors of the alternative network, and,
when the sector of the home network is determined to be busy and the one or more sectors of the alternative network are not determined to be busy, initiate transmission of an instruction to offload one or more wireless devices, connected to the home network within the sector of the home network, to at least one of the one or more sectors of the alternative network.

29. A non-transitory computer-readable medium having instructions stored therein, wherein the instructions, when executed by a processor, cause the processor to:
determine whether a sector of a home network is busy based on one or more measurement reports associated with the sector, wherein the one or more measurement reports indicate at least one performance characteristic of the sector;
when the sector of the home network is determined to be busy, determine whether one or more sectors of an alternative network, which overlap with the sector of the home network, are busy based on at least one performance characteristic of the one or more sectors of the alternative network; and,
when the sector of the home network is determined to be busy and the one or more sectors of the alternative network are not determined to be busy, initiate transmission of an instruction to offload one or more wireless devices, connected to the home network within the sector, to at least one of the one or more sectors of the alternative network.
